(19) United States
(12) Patent Application Publication
(10) Pub. No.: US 2006/0294382 A1
(43) Pub. Date: Dec. 28, 2006

(54) Detecting a watermark using a subset of available detection methods

(75) Inventor: Raymond Krasinski, Suffern, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/569,153

(22) PCT Filed: Aug. 13, 2005
(86) PCT No.: PCT/IB04/51460

§ 371 Date: Feb. 21, 2006

Related U.S. Application Data
(60) Provisional application No. 60/496,129, filed on Aug. 19, 2003.

(51) Int. Cl. H04L 9/00

(52) U.S. Cl. 713/176

(57) ABSTRACT

A system and method are disclosed for detecting watermarked content that also inhibits the successful removal or corruption of the watermark. The method involves utilizing only a subset of candidate counter watermark detection techniques within any particular watermark detector to search for the watermark in an altered form. Since only a subset of counter watermark detection techniques is selected from a larger pool of techniques, a bootlegger will be unaware of the total number of transformations available to the watermark detectors and will therefore not know if the watermark has been successfully removed or corrupted. Thus, it will not be possible for a bootlegger to verify the removal or corruption of the watermark by simply playing out the content through a watermark detection device.

The present invention relates to methods and systems for the protection of digital content through the use of watermark techniques, and more particularly, for encoding, detecting and verifying watermarks in digital content.

Watermarks are embedded signatures in content (e.g., video and audio content) to verify the source of the material. This enables the owners and distributors of content to control and protect their copyrights and other ownership interests, and to control the distribution of the content. The goal of a digital watermark system is to embed an information signal or signals in the content such that there are few or no artifacts in the underlying content signal, while maximizing the encoding level and location sensitivity such that any attempt to remove the watermark will cause damage to the content signal. Generally, a digital watermark is difficult to remove because it shares many of the characteristics of random or pseudo-random noise within the digital content.

Watermarked digital content is distributed to consumers and other users via a variety of methods including Digital Video Disks (DVDs) and Compact Disks (CDs) or downloading the content from a website. The digital content is typically embedded with a payload of information within the watermark, such as the names of the content author and content distributor. When the content is then accessed by a device that has a watermark detection capability, such as a DVD player, a search for the watermark and evaluation of the watermark payload is performed utilizing a watermark detection technique that is associated with that type of watermark. If the proper watermark and watermark payload is found in an unaltered state (typically based on a specified threshold), the device will permit play-out of the content. If a corrupted watermark or improper watermark payload is detected, however, the device will not permit access to the distributed content. Thus, the illegal reproduction and distribution of content will be prohibited.

Typically, a watermark detector searches for the watermark at periodic time intervals during the play out of the content, for example, every 15 seconds. If a corrupted watermark or an improper watermark payload is found during any interval, play out of the content is suspended. If no watermark is found, or an uncorrupted watermark is found during a search of any time interval, then play out of the content is enabled for the current time interval. This process continues for each periodic interval until the available content is exhausted, a corrupted watermark is detected or an improper watermark payload is detected. In the future (when the vast majority of content is expected to contain a watermark), the device may also suspend access to the content if a watermark is not detected during a search of one or more time intervals.

Watermark systems have been defeated, however, by either removing or corrupting the watermark to prevent its detection, thereby enabling the illegal duplication and distribution of the content. Various techniques have been devised to remove or corrupt the watermark. For example, early methods included the resizing or reorienting of the video content including the watermark (e.g., rotating the image 90 degrees before duplication). The watermark detector would not recognize the watermark since it was not in its original orientation. These techniques have evolved in sophistication and have forced the owners and distributors of content to take counter measures to identify illegally duplicated content. Typically, this involves designing a watermark detector that performs a variety of searches for the watermark, each search corresponding to a different technique or transformation used to corrupt or remove the watermark. For instance, the watermark detector could search for the watermark in a position rotated 90 degrees from the original orientation. Techniques for corrupting watermarks are described, for example, in Information Hiding Techniques for Steganography and Digital Watermarking; Stephen Katzenbeisser and Fabian A. P. Petitcolas, editors; Artech House; 105-117 and 142-145 (2000). Techniques to counter reoriented content are described, for example, in G. W. Braudaway, “Protecting Publicly-Available Images with an Invisible Image Watermark,” in Proceedings of the Int'l Conf. on Image Processing, Santa Barbara, Calif. (October 1997).

For each technique developed by the bootlegger, one or more additional search techniques (counter watermark detection techniques) must be undertaken by the watermark detector. Thus, today's watermark detectors are technically complex and consume large amounts of computing power. Due to processing power limitations, however, often only a finite number of tests can be performed on each section of content. In addition, since a watermark detector will typically execute every available counter measure technique, a person attempting to remove or corrupt the watermark can simply play-out the illegal copy in a commercially available player to determine if the watermark was successfully removed or corrupted. If the device still detects the watermark, the bootlegger can simply try another watermark corruption technique. A need therefore exists for an improved method and apparatus for detecting a watermark within digital content or another data set.

Generally, a system and method are disclosed for detecting watermarked content that also inhibit the ability to detect successful removal or corruption of the watermark. A disclosed method for detecting a watermark comprises the steps of selecting a counter watermark detection technique from a subset of available counter watermark detection techniques; and searching for a watermark utilizing the selected counter watermark detection technique.

The method involves utilizing only a subset of candidate counter watermark detection techniques within any particular watermark detector. Since only a subset of counter watermark detection techniques is selected from a larger pool of techniques, a bootlegger will be unaware of the total number of transformations available to the watermark detectors and will therefore not know if the watermark has been successfully removed or corrupted. Thus, it will not be possible for a bootlegger to verify the removal or corruption of the watermark by simply playing out the content through a watermark detection device.

In one embodiment of the present invention, a particular watermark detector will only implement a subset of counter watermark detection techniques from a pool of counter watermark detection techniques. In another embodiment, a particular watermark detector will implement all counter watermark detection techniques, but will only execute the counter watermark detection techniques identified in a subset list of counter watermark detection techniques. In yet another embodiment, a particular watermark detector will only implement a subset of counter watermark detection techniques from a pool of counter watermark detection techniques and will only apply a randomly chosen subset of this implemented subset of watermark detection techniques during each watermark detection time interval.

A more complete understanding of the present invention, as well as further features and advantages of the present invention, will be obtained by reference to the following detailed description and drawings.

FIG. 1 illustrates a conventional system for embedding and detecting watermarks in digital content;

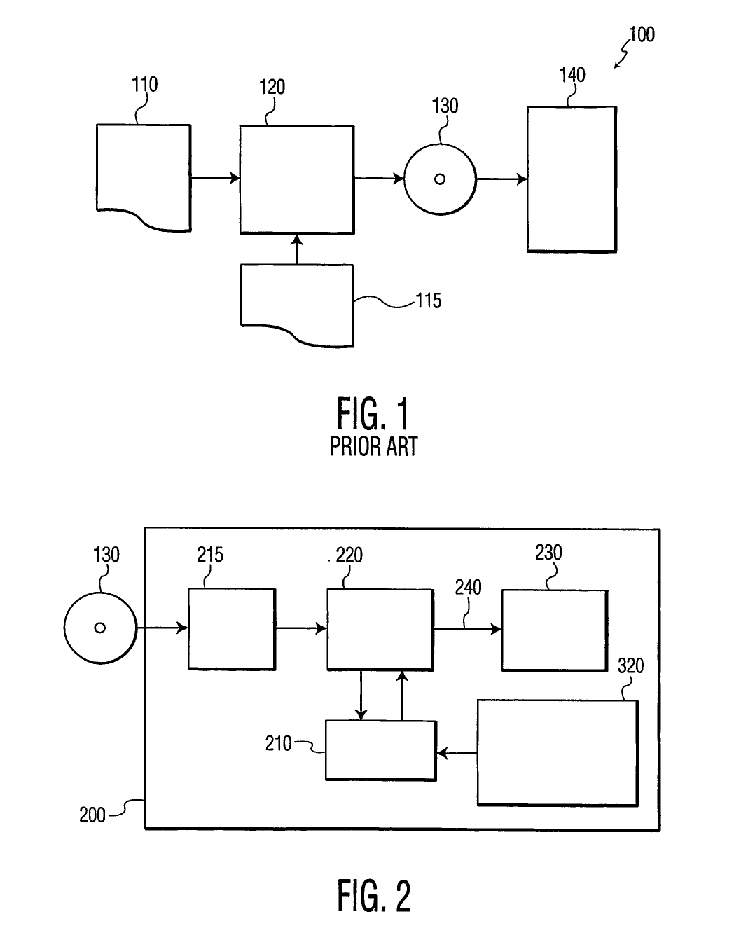

FIG. 2 illustrates a content access device incorporating features of the present invention;

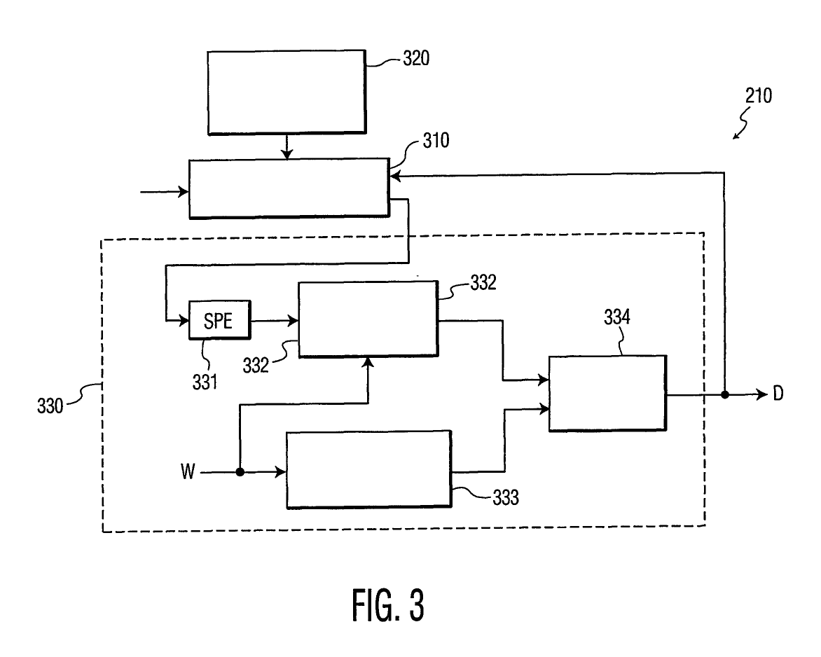

FIG. 3 illustrates the watermark detector of FIG. 2 in further detail; and

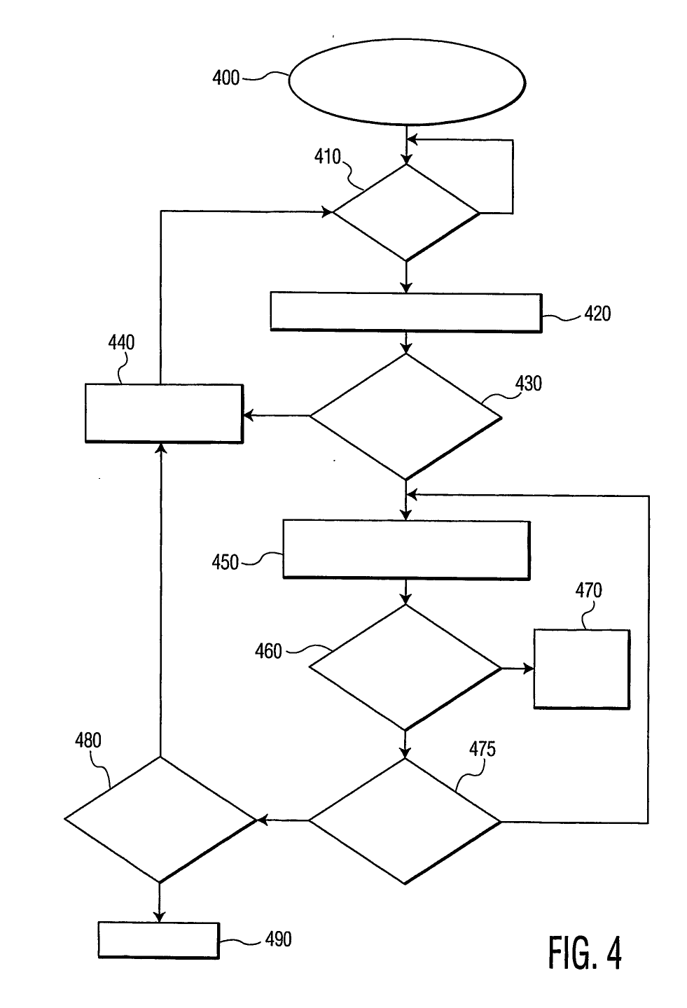

FIG. 4 is a flow chart of an exemplary watermark detector incorporating features of the present invention.

FIG. 1 illustrates a conventional watermark encoding and detection system 100. Content data 110 is processed by watermark encoding processor 120 to add a watermark 115 to the content data 110. Algorithms for embedding watermarks are well known in the art. For a detailed discussion of suitable watermark encoding algorithms, see, for example, U.S. Pat. No. 6,477,431 to Kalker et al., entitled “Watermark Detection,” U.S. Pat. No. 6,570,996 to Linnartz, entitled “Watermarking an Informational Signal,” U.S. Pat. No. 6,505,223 to Haitsma et al., entitled “Watermark Detection,” or U.S. Pat. No. 6,198,832 to Maes et al., entitled “Embedding and Detecting a Watermark in Images,” each incorporated herein by reference. The watermarked content 130 is then distributed via one or more of transmission methods, including networks, DVDs, or CDs (or a combination of the foregoing). A content access device 140, such as a DVD player, is then utilized to play-out the watermarked content 130.

FIG. 2 illustrates a content access device 200 with the watermark detector 210 of the present invention, discussed further below in conjunction with FIG. 3. The content access device 200 may be embodied, for example, as any conventional content access device 140, such as a commercially available DVD player, as modified herein to provide the features and functions of the present invention. As shown in FIG. 2, content data input device 215 accesses content data 130 for presentation, for example, from memory, a DVD or CD. The output device 230 may be, for example, a display or speaker (or a combination thereof) for presenting visual or audio information, respectively. Content data processor 220 transforms the content data 130 for display by output device 230. As the content data 130 is accessed, watermark detector 210 repeatedly searches for a valid watermark 115. A valid watermark 115 is a watermark that has not been altered beyond a specified threshold from its original form. If a valid watermark 115 with its proper payload is detected, watermark detector 210 signals content data processor 220 to continue to process and output content data 240. If watermark detector 210 detects a corrupted watermark 115 (or an improper watermark payload), watermark detector 210 signals content data processor 220 to halt the play-out of output content data 240. A corrupted watermark 115 is a watermark that has been transformed from its original form by one or more techniques, such as rotating the original watermark 90 degrees from its initial orientation.

FIG. 3 is a detailed diagram of watermark detector 210. As shown in FIG. 3, the watermark detector 210 includes a watermark detector core 330, which may be embodied as a typical prior art watermark detector, such as those disclosed in U.S. Pat. No. 6,198,832 to Maes et al., incorporated by reference herein. Generally, the exemplary watermark detector core 330 detects watermarks that result from locally changing the geometric features of images. A “warping” technique is employed by the watermark encoding processor 120 to move the majority of significant pixels to a location within the vicinity of the line pattern. The watermark detector core 330 then constructs a virtual line pattern as an overlay on the distributed content 130. Salient Point Extraction module 331 extracts the salient points from the content data 130. Salient Point Distance Calculator 332 determines the average distance \overline{d}_{w} of the salient points (the set S) of the possibly watermarked image J in accordance with

$${\overline{d}}_{w} = \frac{1}{K} {\sum }_{k ∈ S} {d}_{w , k}$$

where K is the number of salient pixels. Salient Point Average Distance Calculator 333 determines the average distance \overline{d}ᵢ of the salient points of the unwatermarked image in accordance with

$${\overline{d}}_{i} = \frac{1}{K} {\sum }_{k ∈ S} {d}_{i , k} .$$

The watermark detection circuit 334 will then detect the presence of such a watermark if a statistically high percentage of significant pixels lie within the vicinity of the line pattern. Watermark detection circuit 334 concludes that the suspect image J is watermarked (D=1) if the average distance \overline{d}_{w} is significantly smaller than the average distance \overline{d}ᵢ; otherwise it is not (D=0).

Initially, the counter watermark technique processor 310 transparently passes the content acquired by content data processor 220 to watermark detector core 330 in order for a standard search to be performed. A standard search is a search that attempts to discover the watermark in its original form. If no watermark is found, counter watermark technique processor 310 will select and execute a counter watermark detection technique from the pool of counter watermark detection algorithms 320 to determine if the watermark 115 exists in an altered form. The counter watermark detection algorithms 320 effectively reverse any transformation or corruption of the watermark such that a corrupted watermark would be returned to a form that could be detected by watermark detector core 330. Techniques for corrupting watermarks and a counter watermark detection technique for reversing the corruption caused by reorienting a watermark were described earlier.

It should be noted that many counter watermark detection techniques are maintained as trade secrets in order to keep bootleggers unaware of the tools available to content owners and distributors. In the present embodiment, a particular counter watermark detector system 210 of the present invention does not execute every counter watermark technique so that a bootlegger cannot verify that a watermark has been successfully removed. If every counter watermark technique were executed, the bootlegger would simply play-out the content through the content access device to verify the removal of the watermark. In a second embodiment, a particular watermark detector system 210 will only implement a randomly chosen subset of a larger pool of counter watermark techniques. The watermark detector system 210 will thus be able to execute all implemented counter watermark techniques without allowing a bootlegger to verify that all instances of the watermark detector system 210 will not detect the corrupted watermark.

FIG. 4 is a flowchart for the operation of counter watermark technique processor 310. While content data 130 is accessed by content data processor 220, watermark detector 210 searches for the start of a time interval (step 410). If the start of an interval is found during step 410, watermark detector 210 performs a standard search for the watermark during step 420. This standard watermark search involves searching for the watermark during a time interval of the content and, depending on the outcome of the search, either continuing the search in the next time interval or disabling content access. If the original, uncorrupted watermark is discovered at step 430, watermark detector 210 signals content data processor 220 to continue to process and output content data 240 (step 440). A search for the start of the next time interval is then conducted (step 410). If no watermark is found during step 430, watermark detector 210 randomly selects and executes a counter watermark detection technique or a subset of the techniques available from the pool of counter watermark detection techniques 320 to determine if the watermark exists in an altered form (step 450). If watermark detector 210 detects a corrupted watermark (or improper watermark payload) utilizing the selected counter watermark detection technique (step 460), watermark detector 210 signals content data processor 220 to suspend the play-out of content data 110 (step 470). If a corrupted watermark is not found during step 460, a test is made to determine if the search of the current interval is complete (all counter watermark techniques of the subset have been executed or the end of the interval has been reached; step 475). If the search of the current time interval is not complete, another counter watermark technique is selected and executed (step 450); otherwise, a test is made during step 480 to determine if access to the content is still in progress. If access to the content is still in progress, content access is enabled (step 440) and a test is then made to determine if the start of a new interval has occurred (step 410). If access of the content has been completed, then process 400 terminates (step 490).

It is to be understood that the embodiments and variations shown and described herein are merely illustrative of the principles of this invention and that various modifications may be implemented by those skilled in the art without departing from the scope and spirit of the invention.

1. A method for detecting a watermark in content, comprising the steps of:
utilizing only a subset of candidate counter watermark detection techniques for each time interval from a set of available counter watermark detection techniques; and
searching for a watermark utilizing one or more of said subset of candidate counter watermark detection techniques.

2. The method of claim 1, wherein only a second subset of said available counter watermark detection techniques is implemented in a given watermark detector.

3. The method of claim 1, wherein a given watermark detector is provided said subset of available counter watermark detection techniques from a larger pool of available counter watermark detection techniques.

4. The method of claim 2, wherein said first and second subsets of said pool of counter watermark detection techniques are the same.

5. The method of claim 1, wherein said selected counter watermark detection technique is selected randomly from said first subset of a pool of counter watermark detection techniques.

6. The method of claim 1, wherein said steps are repeated until a watermark is detected or all counter watermark detection techniques have been executed.

7. The method of claim 1, further comprising the step of disabling content access if a corrupted watermark is detected.

8. The method of claim 1, further comprising the step of enabling content access if a valid watermark is detected.

9. The method of claim 1, further comprising the step of enabling content access if no watermark has been found after all available counter watermark detection techniques have been executed.

10. The method of claim 1, further comprising the step of restarting said search for a watermark at a beginning of each of said time intervals.

11. The method of claim 1, wherein said subset of a pool of counter watermark detection techniques is selected randomly from all available counter watermark detection techniques.

12. The method of claim 2, wherein said second subset of a pool of counter watermark detection techniques is selected randomly from the first subset of a pool of counter watermark detection techniques.

13. A method for detecting a watermark in content, comprising the steps of:
randomly selecting a counter watermark detection technique from a set of available counter watermark detection techniques; and
searching for a watermark utilizing said selected counter watermark detection technique.

14. The method of claim 13, wherein only a subset of said available counter watermark detection techniques is implemented in a given watermark detector.

15. The method of claim 13, wherein a given watermark detector is provided a subset of available counter watermark detection techniques from a larger pool of available counter watermark detection techniques.

16. The method of claim 13, wherein said set of counter watermark detection techniques is selected randomly from all available counter watermark detection techniques.

17. The method of claim 14, wherein said subset of counter watermark detection techniques is selected randomly from the set of counter watermark detection techniques.

18. The method of claim 13, wherein said steps are repeated until a watermark is detected or all counter watermark detection techniques have been executed.

19. A system for detecting a watermark in content, comprising:
a memory; and
at least one processor, coupled to the memory, operative to:
utilize only a subset of candidate counter watermark detection techniques for each time interval from a set of available counter watermark detection techniques; and
search for a watermark utilizing one or more of said subset of candidate counter watermark detection techniques.

20. A system for detecting a watermark in content, comprising the steps of:
a memory; and
at least one processor, coupled to the memory, operative to:
randomly select a counter watermark detection technique from a set of available counter watermark detection techniques; and
search for a watermark utilizing said selected counter watermark detection technique.
